(19) United States
(12) Patent Application Publication
(10) Pub. No.: US 2023/0385485 A1
(43) Pub. Date: Nov. 30, 2023

(54) SIMULATION METHOD, SIMULATION DEVICE, AND NON-TRANSITORY COMPUTER READABLE MEDIUM STORING PROGRAM

(71) Applicant: SUMITOMO HEAVY INDUSTRIES, LTD., Tokyo (JP)

(72) Inventors: Ryota HIROSE, Yokosuka-shi (JP); Nariaki MATSUMIYA, Yokosuka-shi (JP)

(21) Appl. No.: 18/295,832

(22) Filed: Apr. 4, 2023

(30) Foreign Application Priority Data
May 30, 2022 (JP) 2022-087797

(51) Int. Cl. G06F 30/25; G06F 30/28

(52) U.S. Cl. CPC G06F 30/25; G06F 2113/08; G06F 30/28

(57) ABSTRACT

A simulation method in which a fluid flowing in contact with a wall surface is represented by a plurality of particles, particle-wall surface interaction and interparticle interaction are determined, and an equation of motion governing motion of the plurality of particles is solved for each of the plurality of particles to develop positions and velocities of the plurality of particles over time includes causing, in a case where the equation of motion is solved, attenuation force received from the wall surface and random force according to a temperature of the wall surface, in addition to force due to the interparticle interaction and the particle-wall surface interaction, to act on a particle, among the plurality of particles, whose distance to the wall surface is equal to or less than a first distance set in a simulation condition to develop a position and a velocity of a particle over time.

### CROSS-REFERENCE TO RELATED APPLICATIONS

This application claims priority to Japanese Patent Application No. 2022-087797, filed on May 30, 2022, which is incorporated by reference herein in its entirety.

### BACKGROUND

### Technical Field

A certain embodiment of the present invention relates to a simulation method, a simulation device, and a non-transitory computer readable medium storing a program.

### Description of Related Art

In a method in the related art of analyzing a flow of a fluid in contact with a wall surface by using a molecular dynamics method, the wall surface is represented by a plurality of wall particles, and an interaction between the wall particle and a fluid particle is considered (refer to the related art). With control of a temperature of the wall particle, a temperature of the fluid particle near the wall surface is reproduced.

### SUMMARY

According to one aspect of the present invention, there is provided a simulation method in which a fluid flowing in contact with a wall surface is represented by a plurality of particles, particle-wall surface interaction between the plurality of particles and the wall surface and interparticle interaction between the plurality of particles are determined, and an equation of motion governing motion of the plurality of particles is solved for each of the plurality of particles to develop positions and velocities of the plurality of particles over time, which includes causing, in a case where the equation of motion is solved, attenuation force received from the wall surface and random force according to a temperature of the wall surface, in addition to force due to the interparticle interaction and the particle-wall surface interaction, to act on a particle, among the plurality of particles, whose distance to the wall surface is equal to or less than a first distance set in a simulation condition to develop a position and a velocity of a particle over time.

According to another aspect of the present invention, there is provided a simulation device that analyzes a flow of a fluid flowing along a wall surface, which includes an input unit that receives a simulation condition, a processing unit that analyzes the flow of the fluid based on the simulation condition input to the input unit, and an output unit that outputs an analysis result obtained by the processing unit, in which the processing unit represents the fluid with a plurality of particles based on the simulation condition input to the input unit, solves an equation of motion governing motion of the plurality of particles for each of the plurality of particles to develop positions and velocities of the plurality of particles over time, and causes, in a case where the equation of motion is solved, force due to interparticle interaction and particle-wall surface interaction set in the simulation condition, attenuation force received from the wall surface, and random force according to a temperature of the wall surface, to act on a particle, among the plurality of particles, whose distance to the wall surface is equal to or less than a first distance set in the simulation condition to develop a position and a velocity of a particle over time.

According to still another aspect of the present invention, there is provided a non-transitory computer readable medium storing a program that causes a computer to execute a procedure of analyzing a flow of a fluid flowing along a wall surface, which includes a procedure of acquiring a simulation condition, and a procedure of analyzing the flow of the fluid based on the acquired simulation condition, in which the procedure of analyzing the flow of the fluid includes a procedure of representing the fluid with a plurality of particles based on the acquired simulation condition, and a procedure of solving an equation of motion governing motion of the plurality of particles for each of the plurality of particles to develop positions and velocities of the plurality of particles over time, and in a case where the equation of motion is solved, force due to interparticle interaction and particle-wall surface interaction set in the simulation condition, attenuation force received from the wall surface, and random force according to a temperature of the wall surface are caused to act on a particle, among the plurality of particles, whose distance to the wall surface is equal to or less than a first distance set in the simulation condition to develop a position and a velocity of a particle over time.

### BRIEF DESCRIPTION OF THE DRAWINGS

FIGS. 1A and 1B are cross-sectional views schematically showing an example of an analysis model to be analyzed by a simulation method according to one embodiment.

FIG. 2A is a schematic diagram showing force acting on a particle at a position where a distance from a wall surface is farther than a first distance, and FIG. 2B is a schematic diagram showing force acting on a particle at a position where the distance from the wall surface is equal to or less than the first distance.

FIG. 3 is a block diagram of a simulation device according to the present embodiment.

FIG. 4 is a flowchart showing a procedure of the simulation method according to the present embodiment.

FIG. 5A is a schematic diagram of an analysis model in which a fluid to be analyzed is represented by a plurality of particles, FIG. 5B is a schematic diagram showing a particle system in which a particle system shown in FIG. 5A is isotropically renormalized, and FIG. 5C is a schematic diagram showing a particle system in which the particle system shown in FIG. 5B is not renormalized in a y direction and is further renormalized in an x direction and a z direction.

FIG. 6 is a graph showing distribution of a flow velocity in the x direction in the y direction, which is calculated from an analysis result using an analysis model in which the renormalization is not performed.

FIG. 7 is a graph showing the distribution of the flow velocity in the x direction in the y direction, which is calculated from an analysis result using an analysis model in which the renormalization is performed once in the x, y, and z directions.

FIG. 8 is a graph showing the distribution of the flow velocity in the x direction in the y direction, which is calculated from an analysis result using an analysis model in which the renormalization is performed once in the x direction.

FIG. 9 is a graph showing the distribution of the flow velocity in the x direction in the y direction, which is calculated from an analysis result using an analysis model in which the renormalization is performed once in the y direction.

FIG. 10 is a graph showing the distribution of the flow velocity in the x direction in the y direction, which is calculated from an analysis result using an analysis model in which the renormalization is performed once in the z direction.

FIG. 11 is a graph showing the distribution of the flow velocity in the x direction in the y direction, which is calculated from an analysis result using an analysis model in which the renormalization is performed twice in the x, y, and z directions.

FIG. 12 is a graph showing the distribution of the flow velocity in the x direction in the y direction, which is calculated from an analysis result using an analysis model in which the renormalization is performed twice in the x direction.

FIG. 13 is a graph showing the distribution of the flow velocity in the x direction in the y direction, which is calculated from an analysis result using an analysis model in which the renormalization is performed twice in the y direction.

FIG. 14 is a graph showing the distribution of the flow velocity in the x direction in the y direction, which is calculated from an analysis result using an analysis model in which the renormalization is performed twice in the z direction.

FIG. 15 is a graph showing the distribution of the flow velocity in the x direction in the y direction, which is calculated from an analysis result using an analysis model in which the renormalization is performed three times in the x, y, and z directions.

FIG. 16 is a graph showing the distribution of the flow velocity in the x direction in the y direction, which is calculated from an analysis result using an analysis model in which the renormalization is performed three times in the x direction.

FIG. 17 is a graph showing the distribution of the flow velocity in the x direction in the y direction, which is calculated from an analysis result using an analysis model in which the renormalization is performed three times in the y direction.

FIG. 18 is a graph showing the distribution of the flow velocity in the x direction in the y direction, which is calculated from an analysis result using an analysis model in which the renormalization is performed three times in the z direction.

FIG. 19 is a graph showing the distribution of the flow velocity in the x direction in the y direction, which is calculated from an analysis result using an analysis model in which the renormalization is performed three times in the x, y, and z directions.

FIG. 20 is a graph showing the distribution of the flow velocity in the x direction in the y direction, which is calculated from an analysis result by a method of a comparative example using an analysis model in which the renormalization is performed three times in the x direction.

FIG. 21 is a graph showing the distribution of the flow velocity in the x direction in the y direction, which is calculated from an analysis result by a method of a comparative example using an analysis model in which the renormalization is performed three times in the y direction.

FIG. 22 is a graph showing the distribution of the flow velocity in the x direction in the y direction, which is calculated from an analysis result by a method of a comparative example using an analysis model in which the renormalization is performed three times in the z direction.

FIGS. 23A and 23B are cross-sectional views of an analysis model to be analyzed in a simulation method according to another embodiment.

### DETAILED DESCRIPTION

In a simulation method in the related art, since it is necessary to dispose the wall particle in addition to the fluid particle, the number of particles to be calculated increases. Further, a spatial resolution for a wall surface shape is limited by a particle size of the wall particle.

It is desirable to provide a simulation method, a simulation device, and a non-transitory computer readable medium storing a program capable of analyzing a flow of a fluid in contact with a wall surface without disposing a wall particle for reproducing the wall surface.

Since the wall surface particle that reproduces the wall surface is not disposed, it is possible to suppress an increase in the number of particles to be calculated and reduce a calculation load. With the attenuation force received from the wall surface and the random force according to the temperature of the wall surface being caused to act on the particle of the fluid, it is possible to reproduce the non-slip condition on the wall surface and maintain the temperature of the fluid particle at the temperature of the wall surface.

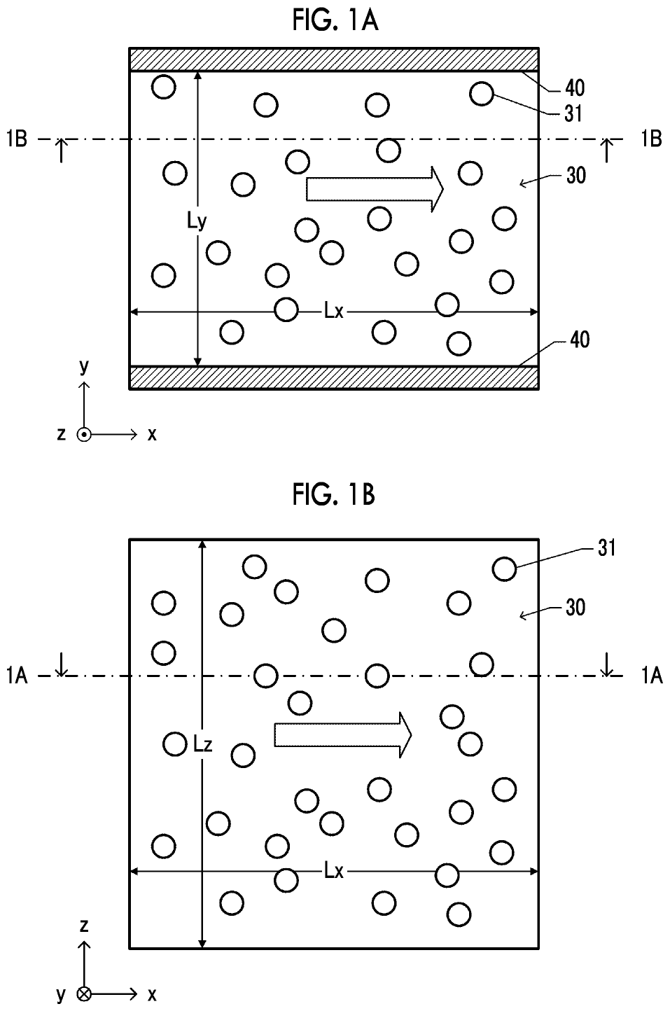

A simulation method, a simulation device, and a non-transitory computer readable medium storing a program according to one embodiment will be described with reference to drawings from FIGS. 1A to 4.

FIGS. 1A and 1B are cross-sectional views schematically showing an example of an analysis model to be analyzed in the simulation method according to one embodiment. FIG. 1A is a cross-sectional view taken along a line 1A-1A of a single point chain line of FIG. 1B, and FIG. 1B is a cross-sectional view taken along a line 1B-1B of a single point chain line of FIG. 1A. A fluid flows in an analysis space 30 defined by a wall surface 40. The wall surface 40 is configured of, for example, a pair of surfaces disposed parallel to each other. An xyz orthogonal coordinate system is defined in which a plane parallel to the wall surface 40 is set as an xz plane and a flow direction of the fluid is set as an x direction.

Sizes of the analysis space 30 between the wall surfaces 40 in x, y, and z directions are respectively marked as Lx, Ly, and Lz. A periodic boundary condition is applied to a boundary perpendicular to the z direction and a boundary perpendicular to the x direction. The fluid in the analysis space 30 is represented by a plurality of particles 31. In the embodiment, behavior of the plurality of particles 31 is analyzed by using a molecular dynamics method or a renormalization group molecular dynamics method. Specifically, an equation of motion governing motion of the plurality of particles 31 is numerically solved, and a position and a velocity of the particle 31 are developed over time.

For example, the following Leonard-Jones potential is used as interaction potential U acting between the particles 31.

$$U ( r ) = 4 ε [ {( \frac{σ}{r} )}^{12} - {( \frac{σ}{r} )}^{6} ] \qquad ( 1 )$$

Here, r is a distance between particles, and ε and σ are fitting parameters having dimensions of energy and length, respectively. σ may be referred to as a collision diameter of the particles.

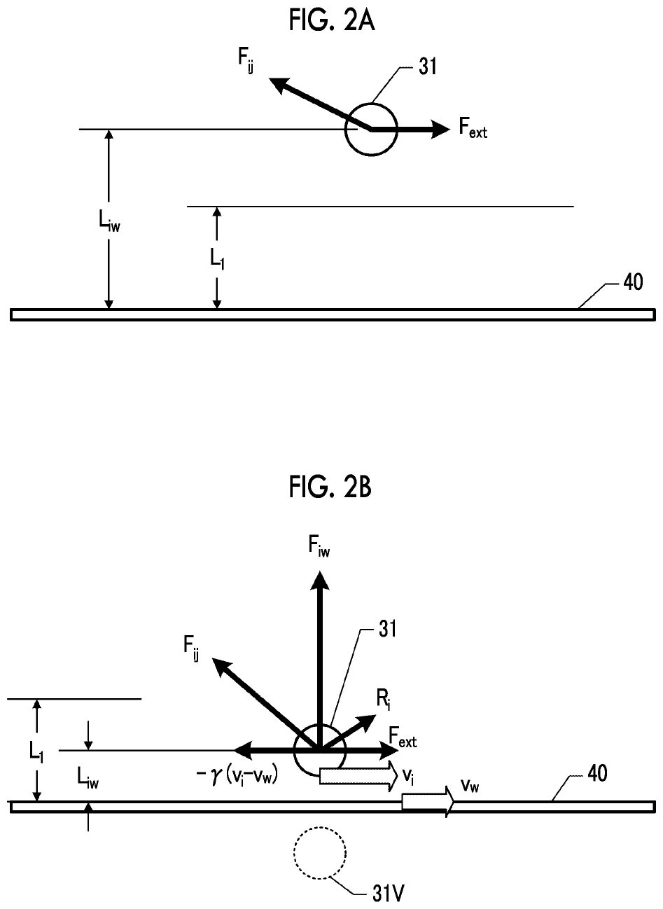

FIG. 2A is a schematic diagram showing force acting on the particle 31 at a position where a distance L_{iw} from the wall surface 40 is farther than a first distance L₁. Here, the subscript i means an i-th particle 31 in a case where the plurality of particles 31 are serially numbered.

The following equation can be applied as the equation of motion governing the motion of the particle 31 at a position where the distance L_{iw} from the wall surface 40 is farther than the first distance L₁.

$$m {\dot{v}}_{i} ( t ) = {\sum }_{j} {F}_{ij} ( t ) + {F}_{ext} \qquad ( 2 )$$

Here, m is mass of the particle 31, and vᵢ is a velocity vector of the i-th particle 31. Fᵢⱼ is force that the i-th particle 31 receives from a j-th particle 31, and can be calculated from the Leonard-Jones potential shown in equation (1). Fₑₓₜ is external force such as gravity that the particle 31 receives. A symbol on the right side of equation (2) means a sum of the particles 31 around the i-th particle 31.

With representation of the wall surface 40 with a plurality of wall particles and consideration of interaction between the particle 31 and the wall particle, a non-slip condition in which a flow velocity becomes zero on the wall surface is reproduced. In the present embodiment, the non-slip condition is reproduced without representing the wall surface with the wall particle.

FIG. 2B is a schematic diagram showing force acting on the particle 31 (hereinafter may be simply referred to as particle 31 near the wall surface) at a position where the distance L_{iw} from the wall surface 40 is equal to or less than the first distance L₁. In a case where an attenuation term is added to the equation of motion governing the particle 31 near the wall surface in order to reproduce the non-slip condition, a temperature of the particle 31 near the wall surface decreases with the passage of time. In the present embodiment, the temperature of the particle 31 near the wall surface is controlled by using a Langevin method.

In a case where the temperature control by the Langevin method is applied, the equation of motion governing the motion of the particle 31 near the wall surface is represented by the following equation.

$$m {\dot{v}}_{i} ( t ) = {\sum }_{j} {F}_{ij} ( t ) + {F}_{ext} + {F}_{iw} ( t ) - γ ( {v}_{i} ( t ) - {v}_{w} ( t ) ) + {R}_{i} ( t ) \qquad ( 3 )$$

Here, F_{iw} is force in a normal direction that the i-th particle 31 receives from the wall surface 40. vᵢ and v_{w} are the velocity vector of the i-th particle 31 and the velocity vector of the wall surface 40 to which the i-th particle 31 approaches, respectively. A fourth term on the right side of equation (3) corresponds to attenuation force (viscous resistance force). The magnitude of the attenuation force is proportional to a relative velocity of the particle 31 to the wall surface 40, and a direction of the attenuation force is opposite to the relative velocity. γ is referred to as an attenuation coefficient. With this attenuation force, the non-slip condition on the wall surface 40 can be reproduced.

Rᵢ is random force applied to maintain the temperature of the particle 31 near the wall surface 40 at a wall surface temperature. The mean of the magnitude of the random force Rᵢ is zero and the standard deviation σₛ thereof follows normal distribution represented by the following equation.

$${σ}_{s} = \sqrt{\frac{2 γ {k}_{B} {T}_{w}}{Δ {t}_{s}}} \qquad ( 4 )$$

Here, k_{B} is a Boltzmann constant, T_{w} is a set temperature of the wall surface 40, and Δtₛ is a time step width in a case where the equation of motion is numerically solved. A direction of the random force Rᵢ is random.

In the temperature control by the Langevin method, the strength of the control changes depending on the attenuation coefficient γ. In a case where the attenuation coefficient γ is set to be small, the temperature control is weakened and temperature followability of the particle 31 deteriorates. On the contrary, in a case where the attenuation coefficient γ is set to be large, a deviation from the set temperature T_{w} may occur or the calculation may fail due to a problem of balance with the time step width Δtₛ.

The attenuation coefficient γ is represented by, for example, the following equation.

γ=2ζ\sqrt{mk} (5)

Here, ζ is an attenuation ratio, and k is a spring constant. For example, 0.707 can be used as the attenuation ratio ζ. The spring constant k can be obtained from a coefficient of a quadratic term in a case where the Leonard-Jones potential (equation (1)) is subjected to Taylor expansion near a saddle point, for example. In this case, the spring constant k can be calculated by the following equation.

$$k = \frac{72 ε}{{2}^{\frac{1}{3}} {σ}^{2}} \qquad ( 6 )$$

For example, 5.23×10⁻¹³ kg/s can be used as the attenuation coefficient γ.

Next, force F_{iw} in the normal direction that the i-th particle 31 receives from the wall surface 40 will be described. In a case where the distance L_{iw} from the particle 31 to the wall surface 40 is equal to or less than the first distance L₁, a virtual particle 31V is disposed at a plane-symmetrical position with respect to the wall surface 40. For example, ½ of the collision diameter σ of equation (1) is employed as the first distance L₁. In FIG. 2B, a circular diameter representing the particle 31 does not represent the collision diameter σ of the particle 31.

The force F_{iw}, from the virtual particle 31V, based on interparticle interaction potential defined by equation (1) is caused to act on the i-th particle 31 near the wall surface. That is, in a case where the particle 31 approach the wall surface 40 to a distance that is ½ or less of the collision diameter σ, the particle 31 receives repulsive force in the normal direction from the wall surface 40.

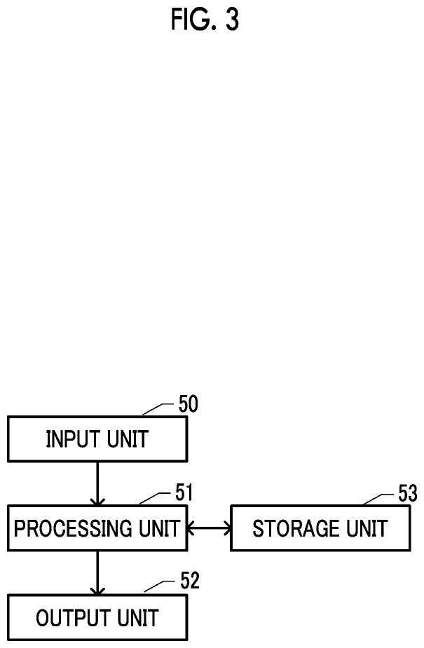

Next, the simulation device according to the present embodiment will be described with reference to FIG. 3. FIG. 3 is a block diagram of the simulation device according to the present embodiment. The simulation device according to the embodiment includes an input unit 50, a processing unit 51, an output unit 52, and a storage unit 53. A simulation condition and the like are input from the input unit 50 to the processing unit 51. Further, various commands and the like are input from an operator to the input unit 50. The input unit 50 is configured of, for example, a communication device, a removable media reading device, or a keyboard.

The processing unit 51 performs the simulation using the molecular dynamics method or the renormalization group molecular dynamics method (hereinafter simply referred to as molecular dynamics method) based on the input simulation condition and command. Further, a simulation result is output to the output unit 52. The simulation result includes, for example, information representing a state of the particle 31 (FIGS. 1A and 1B) reproducing the fluid, which is a simulation object, a spatial change and temporal change in a physical quantity of the fluid, and the like. The processing unit 51 includes, for example, a central processing unit (CPU) of a computer. A program for causing the computer to execute the simulation by the molecular dynamics method is stored in the storage unit 53. The output unit 52 includes a communication device, a removable media writing device, a display, or the like.

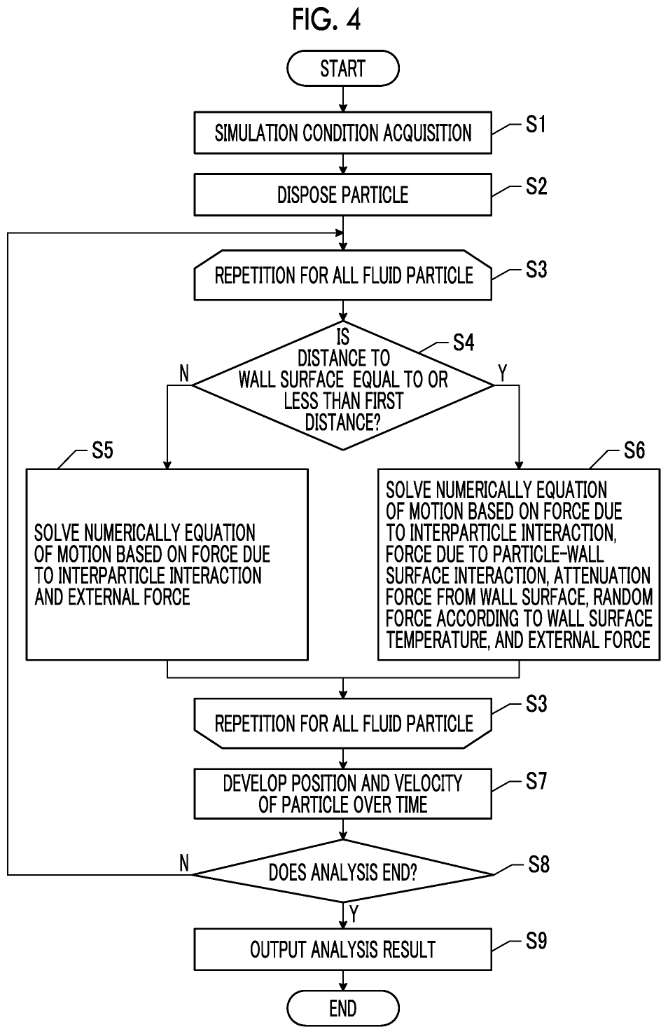

Next, the simulation method according to the present embodiment will be described with reference to FIG. 4. FIG. 4 is a flowchart showing a procedure of the simulation method according to the present embodiment. Each procedure shown in the flowchart is performed by the processing unit 51 executing the program stored in the storage unit 53.

First, the processing unit 51 acquires the simulation condition input to the input unit 50 (step S1). The simulation condition includes information that defines the fluid to be analyzed, information that defines a shape of the wall surface 40 (FIGS. 1A and 1B), information that represents the fluid with the plurality of particles 31 (FIGS. 1A and 1B), information that defines particle-wall surface interaction between the plurality of particles 31 and the wall surface 40, information that defines interparticle interaction between the plurality of particles 31, information that defines a temperature condition, information that defines the attenuation force that the particle 31 near the wall surface receives from the wall surface 40, information that defines external force acting on the particle, the time step width, an analysis end condition, and the like.

The processing unit 51 disposes the plurality of particles 31 in the analysis space 30 (FIGS. 1A and 1B) based on the input simulation condition. After that, procedures of step S4, step S5, and step S6 are repeated for all the particles 31 (step S3). Hereinafter, the repetition processing in step S3 will be described focusing on the i-th particle 31.

First, determination is made whether or not the distance L_{iw} from the i-th particle 31 to the wall surface 40 is equal to or less than the first distance L₁ (step S4). In a case where the distance L_{iw} from the i-th particle 31 to the wall surface 40 is longer than the first distance L₁, the equation of motion (equation (2)) governing the motion of the particle 31 is numerically solved in consideration of the force Fᵢⱼ due to the interparticle interaction shown in FIG. 2A and the external force Fₑₓₜ (step S5). In a case where the distance L_{iw} from the i-th particle 31 to the wall surface 40 is equal to or less than the first distance L₁, the equation of motion (equation (3)) governing the motion of the particle 31 is numerically solved in consideration of the force Fᵢⱼ due to the interparticle interaction shown in FIG. 2B, the force F_{iw} due to the particle-wall surface interaction, attenuation force −γ(vᵢ−v_{w}) according to the relative velocity between the particle 31 and the wall surface, the random force Rᵢ according to the set temperature of the wall surface 40, and the external force Fₑₓₜ (step S6).

The equation of motion is solved for all the particles 31 and then the position and velocity of each of the particles 31 are developed over time (step S7). The repetition processing in step S3 and step S7 are repeated until the analysis ends (step S8). The analysis end condition is provided, for example, by the simulation condition acquired in step S1. In a case where the analysis ends, an analysis result is output to the output unit 52 (step S9).

Next, the excellent effects of the embodiments shown in FIGS. 1A to 4 will be described. In the above embodiment, the analysis is performed without representing the wall surface 40 (FIGS. 1A and 1B) with the plurality of wall particles. Therefore, the number of particles to be analyzed is reduced. As a result, a calculation load can be reduced.

The non-slip condition on a surface of the wall surface 40 can be reproduced by causing the attenuation force −γ(vᵢ−v_{w}) from the wall surface 40 to act on the particles 31 near the wall surface (step S6, FIG. 2B). Further, the temperature of the particles 31 near the wall surface can be maintained at the set temperature by causing the random force Rᵢ according to the temperature of the wall surface 40 to act on the particles 31 near the wall surface (step S6, FIG. 2B).

In the above embodiment, the flow of the fluid flowing through the two wall surfaces disposed in parallel is analyzed. However, even in a case where the wall surface has another shape, the flow of the fluid can be analyzed by applying the simulation method and the simulation device according to the above embodiment.

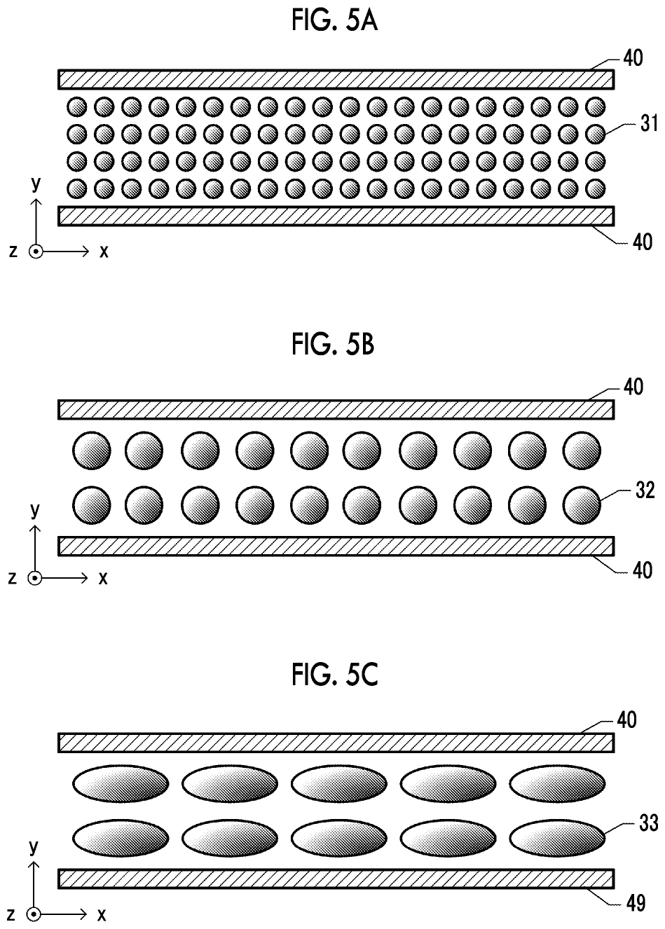

Next, a simulation method, a simulation device, and a non-transitory computer readable medium storing a program according to another embodiment will be described with reference to FIGS. 5A to 5C. In the embodiment described with reference to FIGS. 1A to 4, the particle 31 is not renormalized. In the embodiment described below, the particle 31 is renormalized to reduce the number of particles, and the equations of motion shown in equations (3) and (4) are applied to a particle system after the renormalization.

First, a renormalization method applied in the present embodiment will be described.

FIG. 5A is a schematic diagram of an analysis model in which the fluid to be analyzed is represented by the plurality of particles 31. The fluid to be analyzed is accommodated in a space sandwiched between a pair of wall surfaces 40 disposed in parallel. The fluid is represented by the plurality of particles 31. Each shape of the particle 31 can be considered to correspond to an equipotential surface of the interaction potential generated by the particle 31. In general, the equipotential surface of the interaction potential has a spherical shape. In FIG. 5A, each of the particles 31 is represented by the equipotential surface of a certain size. An xyz orthogonal coordinate system is defined in which a direction in which the wall surfaces 40 are separated is set as the y direction. A size in the y direction of the space in which the fluid is accommodated is sufficiently smaller than sizes in the x direction and the z direction.

FIG. 5B is a schematic diagram showing a particle system in which the particle system shown in FIG. 5A is isotropically renormalized. The number of particles is reduced by the renormalization. The interaction potential is stretched isotropically in the x, y, and z directions. For this reason, in FIG. 5B, each of particles 32 after the renormalization is represented by a spherical surface larger than the particle 31 shown in FIG. 5A.

FIG. 5C is a schematic diagram showing a particle system in which the particle system shown in FIG. 5B is not renormalized in the y direction and is further renormalized in the x direction and the z direction. The number of particles is further reduced by the renormalization. Further, the interaction potential is stretched in the x direction and the z direction, and is not stretched in the y direction. For this reason, in FIG. 5C, each of particles 33 after the renormalization is represented by a flat rotating ellipse with the y direction as a short axis direction.

### Isotropic Renormalization

Next, a renormalization transformation rule in a case where the isotropic renormalization is performed on the particle system and energy of the particle system will be described. The renormalization transformation rule is represented by the following equation.

$${N}_{R} = \frac{N}{{λ}^{3}} \qquad ( 7 )$$

$${m}_{R} = {λ}^{3} m$$

$${r}_{R} = r$$

$${V}_{R} = V$$

$${T}_{R} = {λ}^{3} T$$

Here, N is the number of particles, m is particle mass, r is a position vector indicating a particle position, V is a volume of a flow field of the fluid, and T is a temperature of the particle system. A parameter with a subscript R is represented as a parameter after the renormalization. λ is a parameter (renormalization factor) representing a degree of renormalization, and λ is a real number larger than 1. For example, in a case where the renormalization factor λ is represented by the following equation with n as an integer of 1 or more, n is referred to as the number of times of renormalization.

λ=2ⁿ (8)

The interaction potential u(r) between the particles is provided with a distance between the particles as r. In a case where the distance r approaches infinity and u(r) approaches zero sufficiently quickly (for example, in case of Leonard-Jones potential), the renormalization transformation rule of the interaction potential u(r) is represented by the following equation.

$${u}_{R} ( r ) = {λ}^{3} u ( \frac{r}{λ} ) \qquad ( 9 )$$

In a case where the renormalization processing is performed by using the renormalization transformation rule of the above equations (7) and (9), macroscopic physical quantities such as energy and pressure of the particle system do not change before and after the renormalization. Hereinafter, it will be demonstrated that the energy does not change before and after the renormalization.

A distribution function Z_{N} of the particle system is represented by the following equation.

$${Z}_{N} = \frac{1}{N ! {h}^{3 N}} \int {d}^{3 N} {rd}^{3 N} {pe}^{- β H} \qquad ( 10 )$$

$$β = \frac{1}{{k}_{B} T}$$

$$H = \frac{1}{2 m} {\sum }_{i = 1}^{N} {p}_{i}^{2} + {\sum }_{i < j} u ( {r}_{ij} )$$

Here, h is the Planck's constant, k_{B} is the Boltzmann's constant, r is the position vector of the particle, p is momentum of the particle, and rᵢⱼ is a distance from an i-th particle to a j-th particle. The sigma in a first term on the right side of a third equation in equation (10) means that all of N particles are summed, and the sigma in a second term means that all of particle pairs are summed.

A portion Z_{N:k} of a motion term of the distribution function Z_{N} of equation (10) is represented by the following equation.

$${Z}_{N : k} = \frac{{V}^{N}}{N !} \int {d}^{3 N} {pe}^{- β \frac{1}{2 m} {\sum }_{i = 1}^{N} {p}_{i}^{2}} = \frac{{V}^{N}}{N !} {( \frac{2 π m}{β} )}^{\frac{3 N}{2}} \qquad ( 11 )$$

Therefore, kinetic energy Eₖ is represented by the following equation.

$${E}_{k} = - \frac{\partial }{\partial β} ln {Z}_{N : k} = \frac{3 N}{2 β} \qquad ( 12 )$$

In a case where the renormalization of the renormalization factor λ is performed, both N and β on the right side of equation (12) become 1/λ³. Therefore, the kinetic energy Eₖ does not change before and after the renormalization.

A portion Z_{N:int} of an interaction term of the distribution function Z_{N} of equation (10) is represented by the following equation.

$${Z}_{N : int} = \frac{1}{{V}^{N}} \int {d}^{3 N} {re}^{- β U} \qquad ( 13 )$$

$$U = {\sum }_{i < j}^{} u ( {r}_{ij} )$$

In a case where the distance rᵢⱼ approaches infinity, u(rᵢⱼ) approaches zero sufficiently quickly. Therefore, the interaction potential u(r) in a case of r>r_{c} can be approximated as follows, using a certain cutoff distance r_{c}.

u(r)=0

e^{-βu(r)}=1 (14)

A case is considered in which the cutoff distance r_{c} is sufficiently smaller than lengths Lₓ, L_{y}, and L_{z} of the space accommodating the fluid in the x, y, and z directions and particle number density N/V is sufficiently small. In this case, the probability that another particle is present in a range where the distance from each particle is equal to or less than the cutoff distance r_{c} is extremely small. In particular, the probability that two or more other particles are present in the range where the distance from each particle is equal to or less than the cutoff distance r_{c} may be regarded as zero. Therefore, the multiple integral (equation (13)) of the distribution function Z_{N:int} can be approximated as follows.

$${Z}_{N : int} \approx {( \int \frac{{d}^{3} r}{V} {e}^{- β u ( r )} )}^{\frac{N ( N - 1 )}{2}} = {( \int \frac{{d}^{3} r}{V} f ( r ) + 1 )}^{\frac{N ( N - 1 )}{2}} \approx exp ( \frac{N ( N - 1 )}{2} \int \frac{{d}^{3} r}{V} f ( r ) ) \approx exp ( \frac{{N}^{2}}{2 V} \int {d}^{3} rf ( r ) ) \qquad ( 15 )$$

$$f ( r ) = {e}^{- β u ( r )} - 1$$

Therefore, interaction energy Eᵢₙₜ can be approximated by the following equation.

$${E}_{int} = - \frac{\partial }{\partial β} ( \frac{{N}^{2}}{2 V} \int {d}^{3} rf ( r ) ) \qquad ( 16 )$$

The total energy E of the particle system is defined by the following equation.

E=Eₖ+Eᵢₙₜ (17)

In a case where the cutoff distance r_{c} is sufficiently smaller than Lₓ, L_{y}, and L_{z}, and the interparticle distance r is larger than the cutoff distance r_{c}, u(r)=0 can be approximated. Therefore, the volume integral of equation (16) can be approximated as follows.

$$\int {d}^{3} rf ( r ) = {{\int }_{- {L}_{x} / 2}}^{{L}_{x} / 2} dx {{\int }_{- {L}_{y} / 2}}^{{L}_{y} / 2} dy {{\int }_{- {L}_{z} / 2}}^{{L}_{z} / 2} dzf ( r ) \approx {{\int }_{- ∞}}^{∞} dx {{\int }_{- ∞}}^{∞} dy {{\int }_{- ∞}}^{∞} dzf ( r ) \qquad ( 18 )$$

Interaction energy E_{int,R} after the renormalization transformation is approximated by the following equation.

$${E}_{int , R} = - \frac{\partial }{\partial ( β / {λ}^{3} )} \times ( \frac{{( N / {λ}^{3} )}^{2}}{2 V} \int ( {e}^{- ( β / {λ}^{3} ) ( {λ}^{3} u ( r / λ ) )} - 1 ) {d}^{3} r ) \qquad ( 19 )$$

There is a need to satisfy a condition that a cutoff distance r_{cR} after the renormalization transformation is sufficiently smaller than Lₓ, L_{y}, and L_{z} in order to establish the approximation of equation (18). From equation (9), the cutoff distance r_{cR} after the renormalization transformation is A times the cutoff distance r_{c} before the renormalization transformation. In a case where the renormalization factor λ is increased, the cutoff distance r_{cR} becomes longer. For this reason, an upper limit of the renormalization factor λ is constrained by the condition that the cutoff distance r_{cR} after the renormalization transformation is sufficiently smaller than Lₓ, L_{y}, and L_{z}.

In a case where r is variable-converted to λr in equation (19), equation (19) becomes the same as the right side of equation (16). Therefore, E_{int,R}=Eᵢₙₜ is established, and the interaction energy Eᵢₙₜ is also unchanged before and after the renormalization.

In this manner, in a case where the isotropic renormalization is performed using the renormalization transformation rule shown in equation (7), the kinetic energy and the interaction energy of the system do not change before and after the renormalization. Therefore, the energy of the entire system shown in equation (17) is also unchanged before and after the renormalization.

### Renormalization in Two Directions

Next, a case will be described in which the cutoff distance r_{c} is sufficiently shorter than the size Lₓ in the x direction and the size L_{z} in the z direction of the flow field, but is not sufficiently shorter than the size L_{y} in the y direction. For example, in a case where the flow field has a thin plate shape with the y direction as a thickness direction, the above condition is satisfied.

In a case where the shape of the flow field satisfies such a condition, the renormalization is not performed in the y direction, but is performed in only two directions of the x direction and the z direction. The renormalization transformation rule is represented by the following equation.

$${N}_{R} = \frac{N}{{λ}^{2}} \qquad ( 20 )$$

$${m}_{R} = {λ}^{2} m$$

$${r}_{R} = r$$

$${V}_{R} = V$$

$${T}_{R} = {λ}^{2} T$$

The interaction potential follows the following transformation rule.

$${u}_{R} ( r ) = {λ}^{2} u ( \tilde{r} ) \qquad ( 21 )$$

$$\tilde{r} = \sqrt{\frac{{x}^{2}}{{λ}^{2}} + \frac{{z}^{2}}{{λ}^{2}} + {y}^{2}}$$

Even in a case where the renormalization transformation of equation (20) is performed, the kinetic energy represented by equation (12) does not change before and after the renormalization.

The volume integral of equation (16) can be approximated as follows.

$$\int {d}^{3} rf ( r ) = {{\int }_{- {L}_{x} / 2}}^{{L}_{x} / 2} dx {{\int }_{- {L}_{y} / 2}}^{{L}_{y} / 2} dy {{\int }_{- {L}_{z} / 2}}^{{L}_{z} / 2} dzf ( r ) \approx {{\int }_{- ∞}}^{∞} dx {{\int }_{- {L}_{z} / 2}}^{{L}_{z} / 2} dy {{\int }_{- ∞}}^{∞} dzf ( r ) \qquad ( 22 )$$

The interaction energy E_{int,R} after the renormalization transformation is approximated by the following equation.

$${E}_{int , R} = - \frac{\partial }{\partial ( \frac{β}{{λ}^{2}} )} \times ( \frac{{( \frac{N}{{λ}^{2}} )}^{2}}{2 V} \int ( {e}^{- ( \frac{β}{{λ}^{2}} ) ( {λ}^{2} u ( \tilde{r} ) )} - 1 ) {d}^{3} r ) \qquad ( 23 )$$

Here, r-tilde is the same as r-tilde of equation (21). In a case where x is variable-converted to λx and z is variable-converted to λz in equation (23), the right side of equation (23) becomes the same as the right side of equation (16). Therefore, E_{int,R}=Eᵢₙₜ is established, and the interaction energy Eᵢₙₜ is also unchanged before and after the renormalization.

In this manner, with the anisotropic renormalization based on the renormalization transformation rule in the two directions shown in equation (20), the energy of the particle system can be unchanged before and after the renormalization.

### Renormalization in One Direction

Next, a case will be described in which the cutoff distance r_{c} is sufficiently shorter than the size Lₓ in the x direction of the flow field, but is not sufficiently shorter than the size L_{y} in the y direction and the size L_{z} in the z direction. For example, in a case where the flow field has an elongated cylindrical shape with the x direction as a length direction, the above condition is satisfied.

In a case where the shape of the flow field satisfies such a condition, the renormalization is not performed in the y direction and the z direction, but is performed only in the x direction. The renormalization transformation rule is represented by the following equation.

$${N}_{R} = \frac{N}{λ} \qquad ( 24 )$$

$${m}_{R} = λ m$$

$${r}_{R} = r$$

$${V}_{R} = V$$

$${T}_{R} = λ T$$

The interaction potential follows the following transformation rule.

$${u}_{R} ( r ) = λ u ( \tilde{r} ) \qquad ( 25 )$$

$$\tilde{r} = \sqrt{\frac{{x}^{2}}{{λ}^{2}} + {y}^{2} + {z}^{2}}$$

Even in a case where the renormalization transformation of equation (24) is performed, the kinetic energy represented by equation (12) does not change before and after the renormalization.

The volume integral of equation (16) can be approximated as follows.

$$\int {d}^{3} rf ( r ) = {{\int }_{- {L}_{x} / 2}}^{{L}_{x} / 2} dx {{\int }_{- {L}_{y} / 2}}^{{L}_{y} / 2} dy {{\int }_{- {L}_{z} / 2}}^{{L}_{z} / 2} dzf ( r ) \approx {{\int }_{- ∞}}^{∞} dx {{\int }_{- {L}_{y} / 2}}^{{L}_{y} / 2} dy {{\int }_{- {L}_{z} / 2}}^{{L}_{z} / 2} dzf ( r ) \qquad ( 26 )$$

The interaction energy E_{int,R} after the renormalization transformation is approximated by the following equation.

$${E}_{int , R} = - \frac{\partial }{\partial ( \frac{β}{λ} )} \times ( \frac{{( \frac{N}{λ} )}^{2}}{2 V} \int ( {e}^{- ( \frac{β}{λ} ) ( λ u ( \tilde{r} ) )} - 1 ) {d}^{3} r ) \qquad ( 27 )$$

Here, r-tilde is the same as the r-tilde of equation (25). In a case where x is variable-converted to λx in equation (27), the right side of equation (27) becomes the same as the right side of equation (16). Therefore, E_{int,R}=Eᵢₙₜ is established, and the interaction energy Eᵢₙₜ is also unchanged before and after the renormalization.

In this manner, with the anisotropic renormalization based on the renormalization transformation rule in one direction shown in equation (24), the energy of the particle system can be unchanged before and after the renormalization.

### Generalization of Anisotropic Renormalization

Equation (20) shows the renormalization transformation rule in a case where the renormalization is performed in two directions and is not performed in a remaining one direction. Equation (24) shows the renormalization transformation rule in a case where the renormalization is not performed in two directions and is performed only in the remaining one direction. Next, a case will be described in which the degree of the renormalization is determined for each of the three directions and the anisotropic renormalization is performed.

The renormalization factors in the x direction, y direction, and z direction are respectively marked as λₓ, λ_{y}, and λ_{z}. The renormalization transformation rule in this case is represented by the following equation.

$${N}_{R} = \frac{N}{{λ}_{x} {λ}_{y} {λ}_{z}} \qquad ( 28 )$$

$${m}_{R} = {λ}_{x} {λ}_{y} {λ}_{z} m$$

$${r}_{R} = r$$

$${V}_{R} = V$$

$${T}_{R} = {λ}_{x} {λ}_{y} {λ}_{z} T$$

The interaction potential follows the following transformation rule.

$${u}_{R} ( r ) = {λ}_{x} {λ}_{y} {λ}_{z} u ( \tilde{r} ) \qquad ( 29 )$$

$$\tilde{r} = \sqrt{\frac{{x}^{2}}{{λ}_{x}^{2}} + \frac{{y}^{2}}{{λ}_{y}^{2}} + \frac{{z}^{2}}{{λ}_{z}^{2}}}$$

Cutoff distances r_{cxR}, r_{cyR}, and r_{czR} of the interaction potential u_{R}(r) after the renormalization transformation in the x, y, and z directions are represented by the following equations.

r_{cxR}=λₓr_{c}

r_{cyR}=λ_{y}r_{c}

r_{czR}=λ_{z}r_{c} (30)

In this case, it is preferable to satisfy the following condition in order to establish an approximation similar to the approximations of equations (18), (22), and (26).

r_{cxR}<<Lₓ

r_{cyR}<<L_{y}

r_{czR}<<L_{z} (31)

Next, in order to apply the equations of motion shown in Equations (3) and (4) to the particle system after the renormalization, a transformation rule for the attenuation coefficient γ is required to be defined. The attenuation coefficient after the renormalization is marked as γ_{R}. In a case where the isotropic renormalization is performed, similar results can be obtained between the particle system before the renormalization and the particle system after the renormalization, in a case where the following transformation rule is applied.

γ_{R}=λ²γ (32)

In a case where the anisotropic renormalization is performed, the following transformation rule is considered to be applied, from equation (32).

$${γ}_{R} = {( {λ}_{x} {λ}_{y} {λ}_{z} )}^{\frac{2}{3}} γ \qquad ( 33 )$$

However, in a case where the simulation is performed on the particle system subjected to the renormalization using an attenuation coefficient γ_{R} obtained by using the transformation rule of equation (33), similar results cannot be obtained between the particle systems before and after the renormalization. With various analyzes by the inventors of the present application, it has been found that similar results can be obtained before and after the renormalization in a case where the following transformation rule is applied with the flow direction of the fluid of the x direction.

$${γ}_{R} = \frac{{{λ}_{y}}^{\frac{4}{3}} {{λ}_{z}}^{\frac{4}{3}}}{{{λ}_{x}}^{\frac{2}{3}}} γ \qquad ( 34 )$$

Next, the excellent effects of the present embodiment will be described.

In the present embodiment, with the renormalization, it is possible to reduce the number of particles and thus the calculation load. Further, with the anisotropic renormalization according to the shape of the analysis space, it is possible to further reduce the number of particles and thus the calculation load.

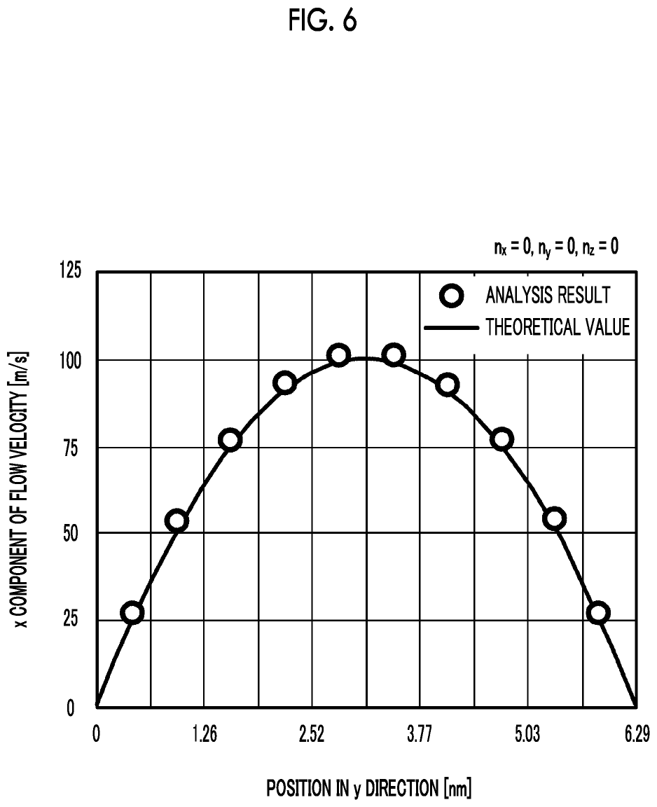

Next, results of actual simulation will be described with reference to FIGS. 6 to 22. The analysis model of the Poiseuille flow shown in FIGS. 1A and 1B is analyzed by a method of not performing the renormalization, a method of performing the isotropic renormalization, and a method of performing the anisotropic renormalization. The periodic boundary condition is applied to the x direction and the z direction. Both the size Lₓ in the x direction and the size L_{z} in the z direction are set to 7.20 nm, and the size L_{y} in the y direction is set to 6.29 nm.

An analysis model is created such that dimensionless lengths are maintained the same even after the renormalization. Water (H₂O) is assumed as the fluid to be analyzed, the fitting parameter c of equation (1) is set to 404.5K, and σ is set to 0.264 nm. Further, external force in the x direction is caused to act as the external force Fₑₓₜ of the equations (2) and (3). The magnitude of the external force is set such that a maximum value of the flow velocity is approximately 100 m/s. The temperature of the wall surface 40 is made equal to an initial value of the temperature of the particle system.

The analysis is performed until the flow reaches a steady state, and the flow velocity in the x direction is calculated from a movement speed of the particle 31 in the steady state. FIGS. 6 to 22 are graphs showing distribution of the flow velocity in the x direction calculated from analysis results in the y direction. The horizontal axis represents a position in the y direction, that is, a distance from one wall surface 40 in unit [nm], and the vertical axis represents an x direction component of the flow velocity in unit [m/s]. A solid line of each graph indicates a theoretical value, and a circle symbol indicates the flow velocity obtained from the analysis result. The nₓ, n_{y}, and n_{z} assigned to each graph represent the number of times of renormalization in the x direction, the y direction, and the z direction, respectively. That is, the number of times of renormalization is defined by the following equation.

λₓ=2ⁿ^{ₓ}

λ_{y}=2ⁿ^{_{y}}

λ_{z}=2ⁿ^{_{z}} (35)

The renormalization condition designated by the number of times of renormalization nₓ, n_{y}, and n_{z}, the renormalization factor λₓ, λ_{y}, and λ_{z}, or the like is provided, for example, by the simulation condition acquired in step S1 of FIG. 4.

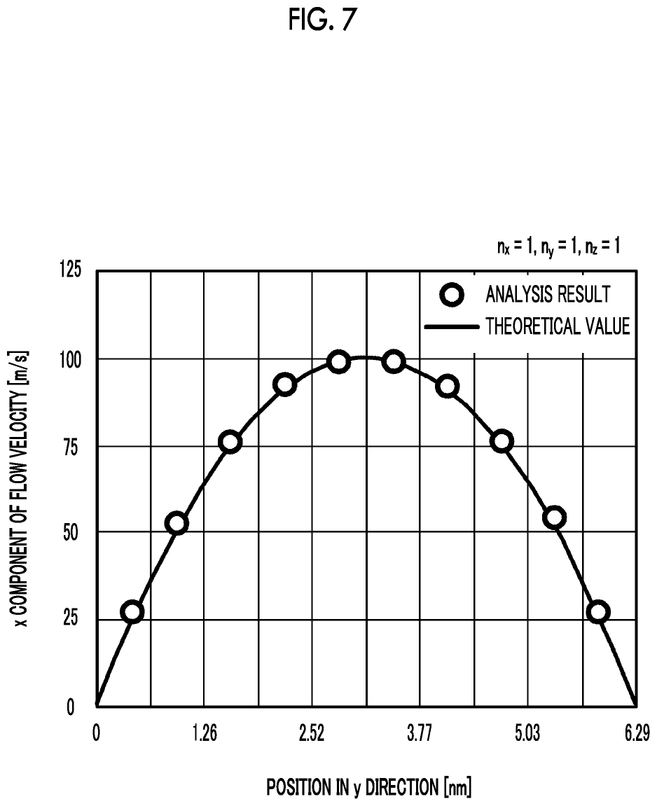

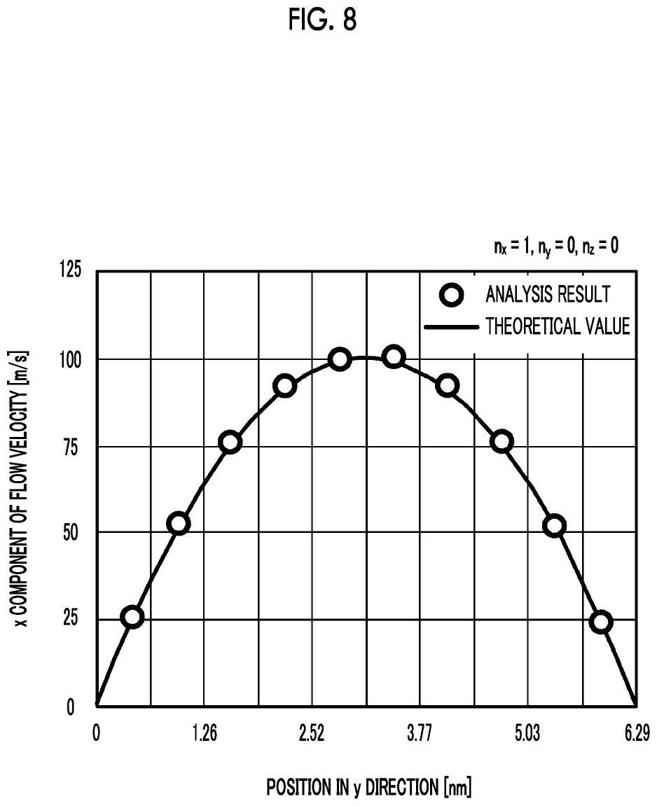

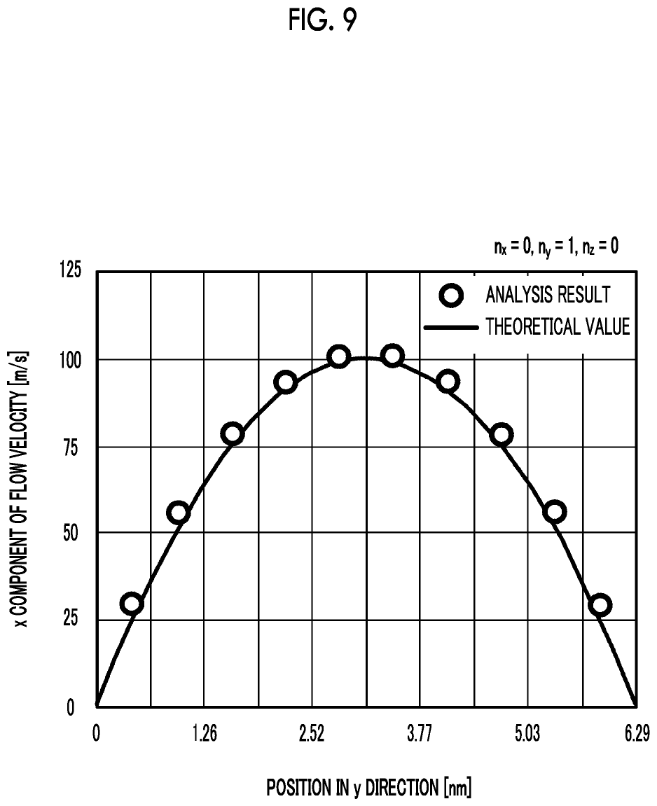

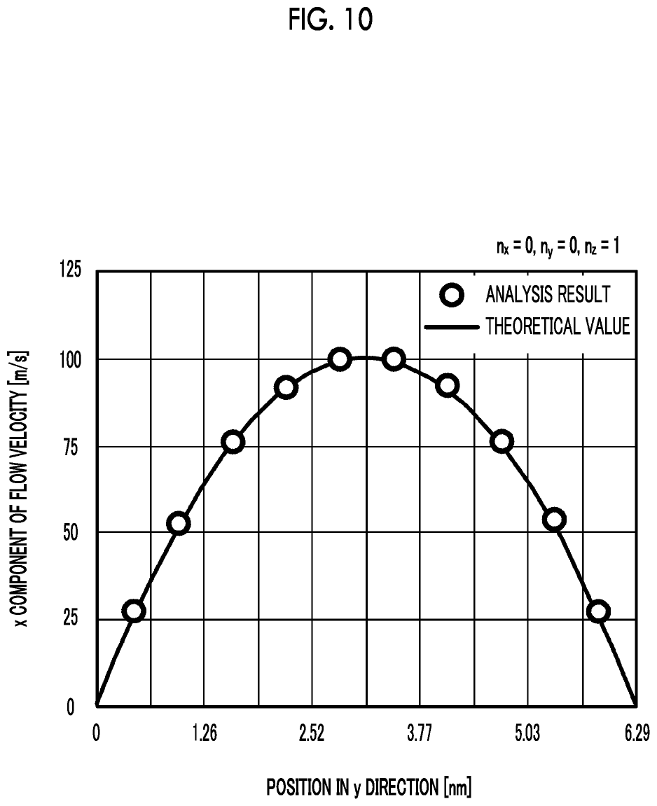

FIG. 6 shows an analysis result in a case where the renormalization is not performed. The attenuation coefficient γ is set to 5.23×10⁻¹³ kg/s. An average error of the analysis result with respect to the theoretical value is about 3.8%, and it can be seen that the analysis result matches well the theoretical value. FIG. 7 shows an analysis result in a case where the renormalization is performed isotropically once each. FIG. 8, FIG. 9, and FIG. 10 show analysis results in a case where the renormalization is performed once in the x direction, the y direction, and the z direction, respectively, and the renormalization is not performed in the other directions. In FIGS. 7 to 10, the renormalization transformation rule of equation (34) is used. The average errors of the analysis results shown in FIG. 7, FIG. 8, FIG. 9, and FIG. 10 with respect to the theoretical values are respectively approximately 2.5%, approximately 2.2%, approximately 7.5%, and approximately 3.2%, and it can be seen that the analysis results match well the theoretical values.

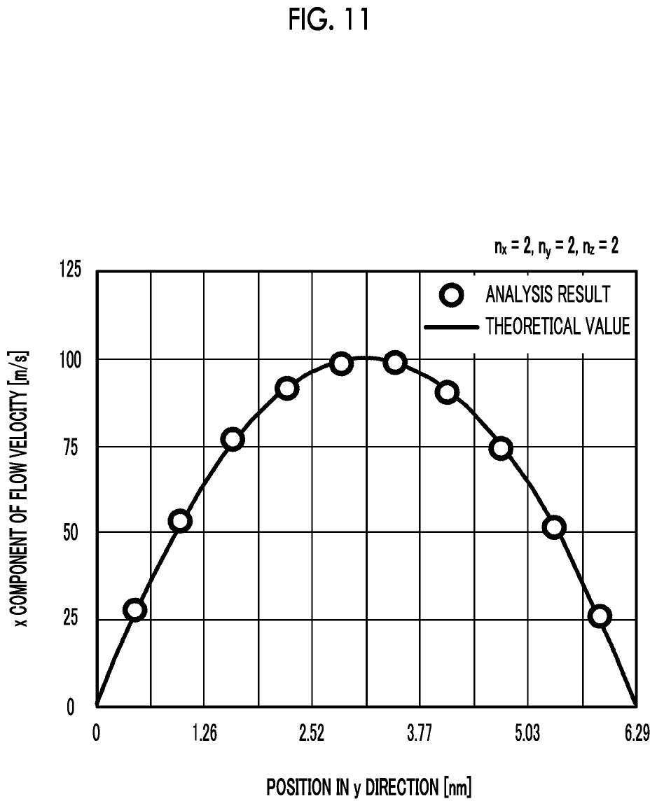

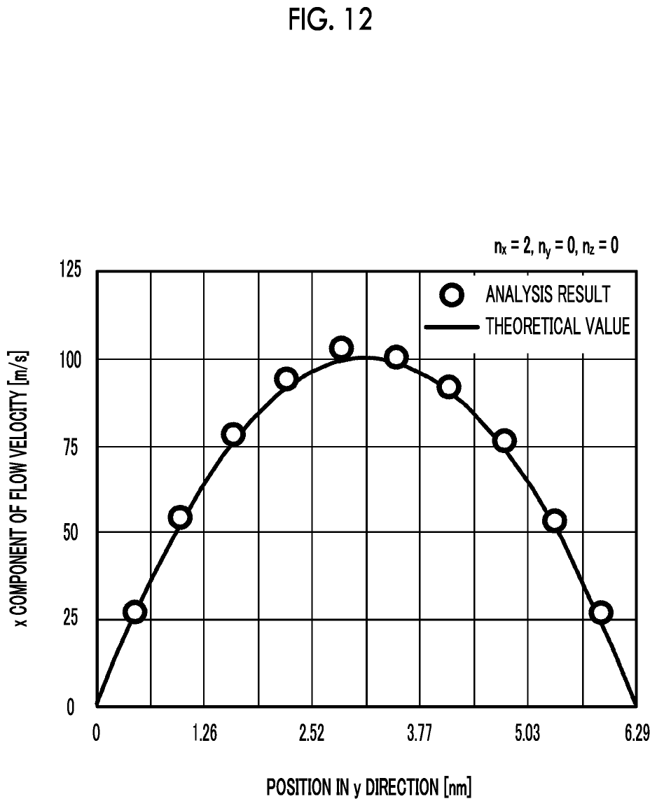

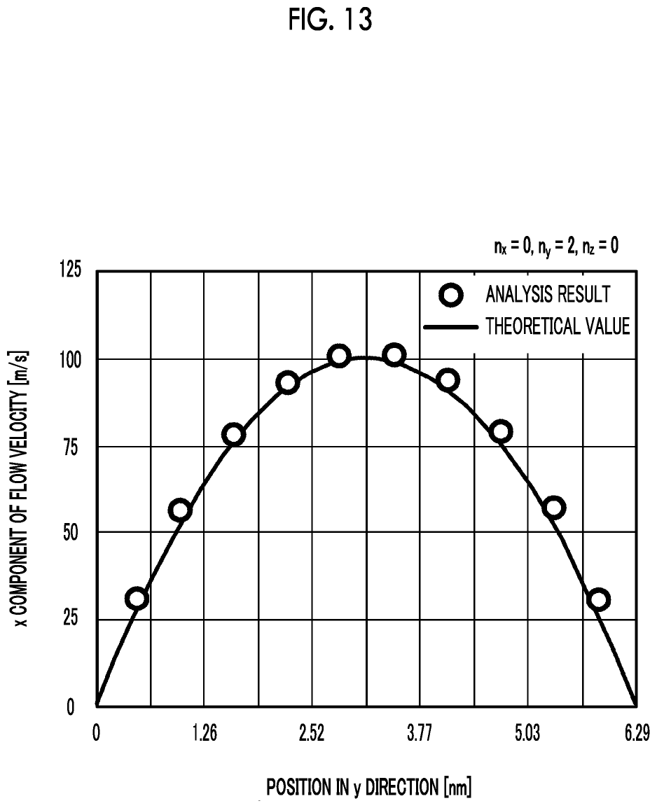

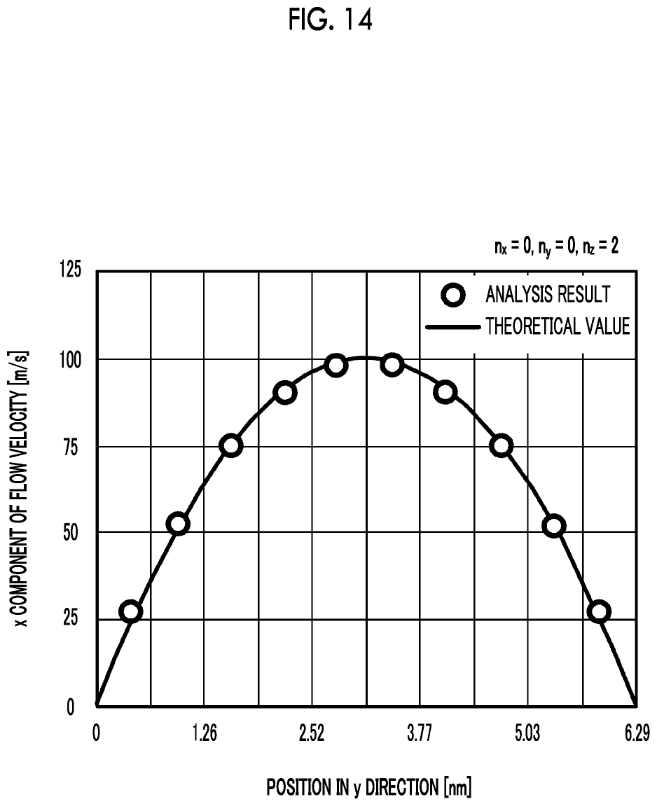

FIG. 11 shows an analysis result in a case where the renormalization is performed isotropically twice each. FIG. 12, FIG. 13, and FIG. 14 show analysis results in a case where the renormalization is performed twice in the x direction, the y direction, and the z direction, respectively, and the renormalization is not performed in the other directions. In FIGS. 11 to 14, the renormalization transformation rule of equation (34) is used. The average errors of the analysis results shown in FIGS. 11, 12, 13, and 14 with respect to the theoretical values are respectively approximately 1.9%, approximately 4.2%, approximately 8.4%, and approximately 2.7%, and it can be seen that the analysis results match well the theoretical values.

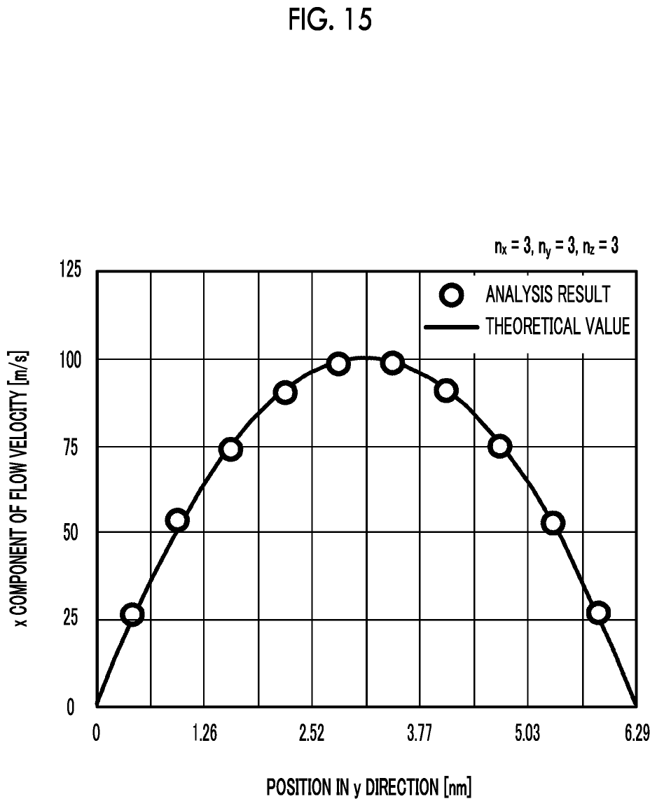

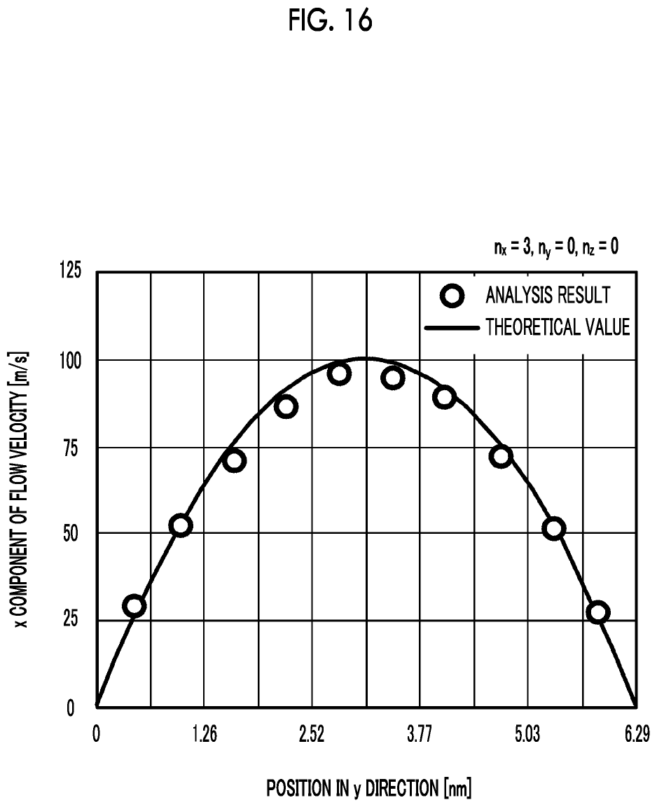

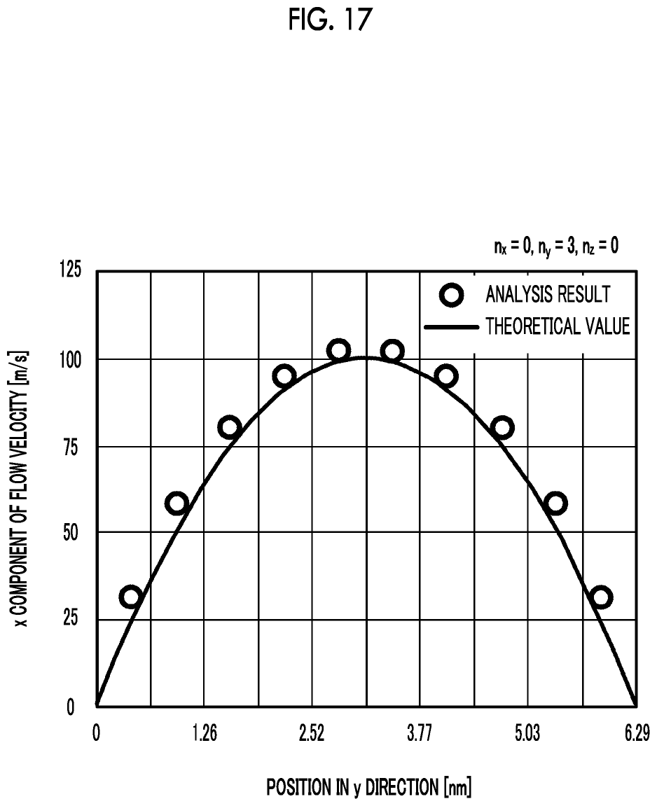

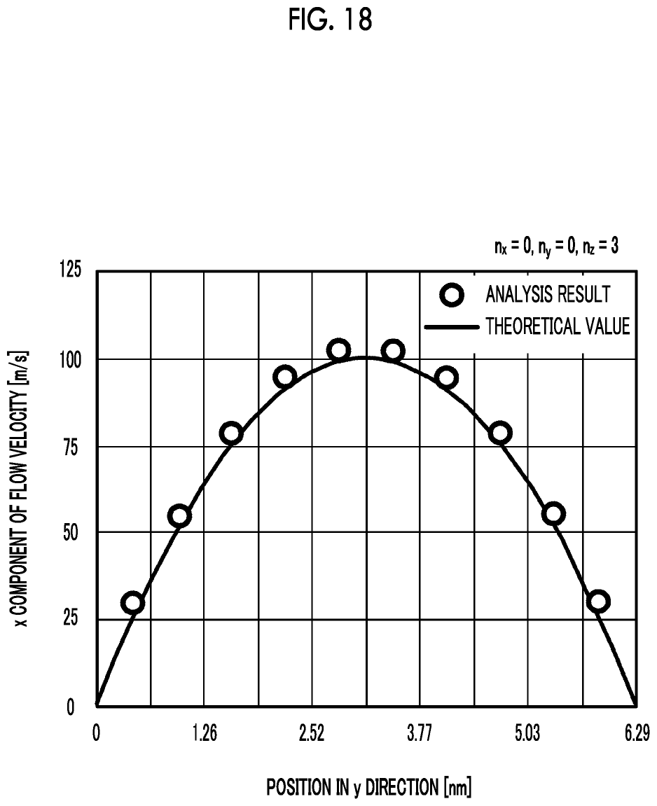

FIG. 15 shows an analysis result in a case where the renormalization is performed isotropically three times each. FIG. 16, FIG. 17, and FIG. 18 show analysis results in a case where the renormalization is performed three times in the x direction, the y direction, and the z direction, respectively, and the renormalization is not performed in the other directions. In FIGS. 15 to 18, the transformation rule of equation (34) is used. The average errors of the analysis results shown in FIGS. 15, 16, 17, and 18 with respect to the theoretical values are respectively approximately 2.7%, approximately 4.4%, approximately 10.0%, and approximately 7.2%, and it can be seen that the analysis results match well the theoretical values.

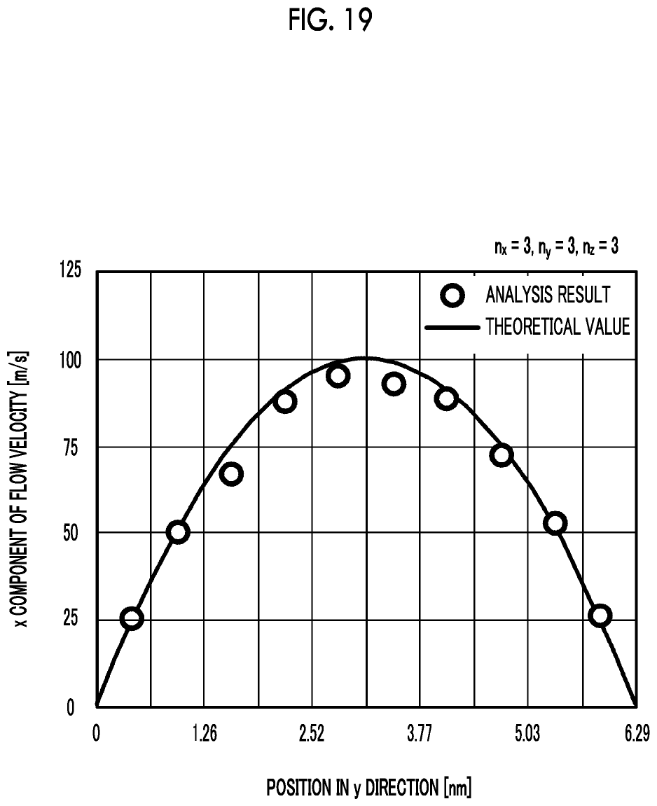

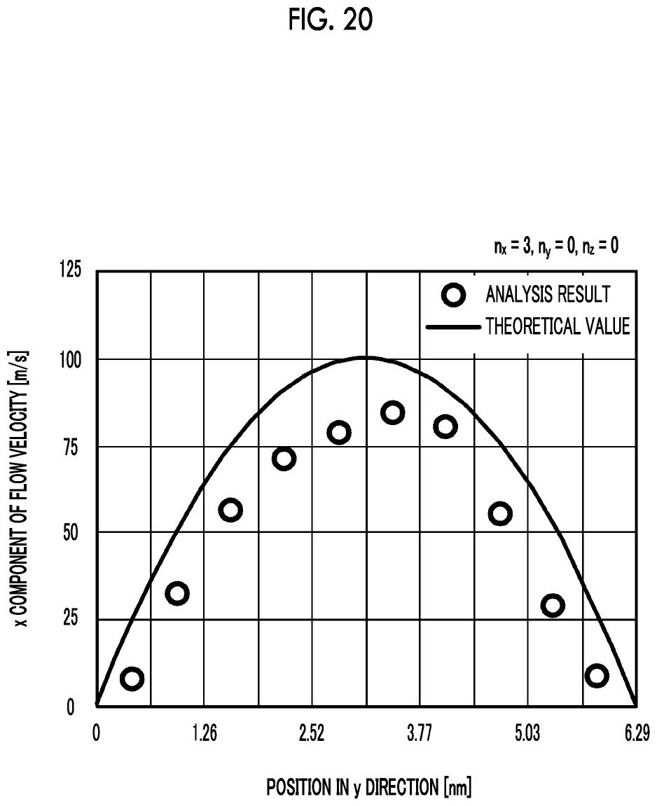

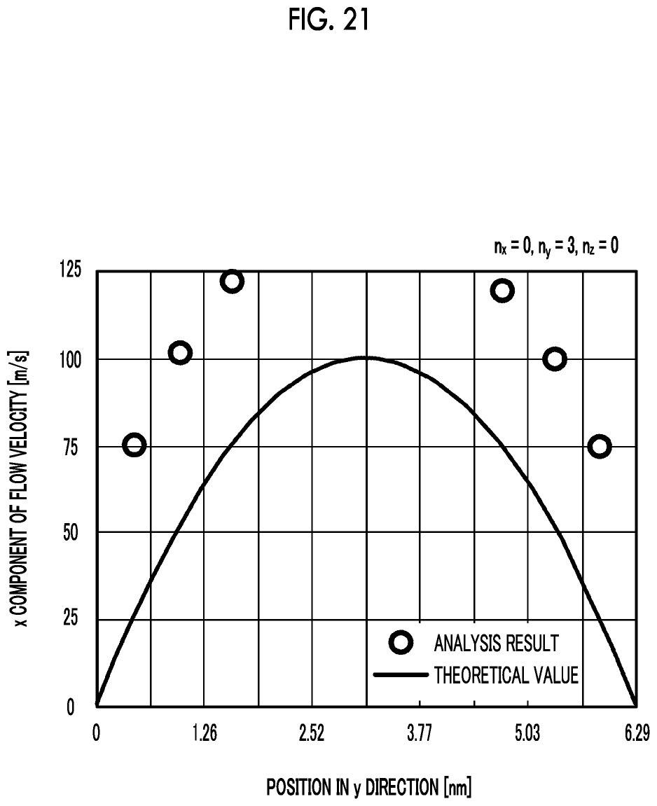

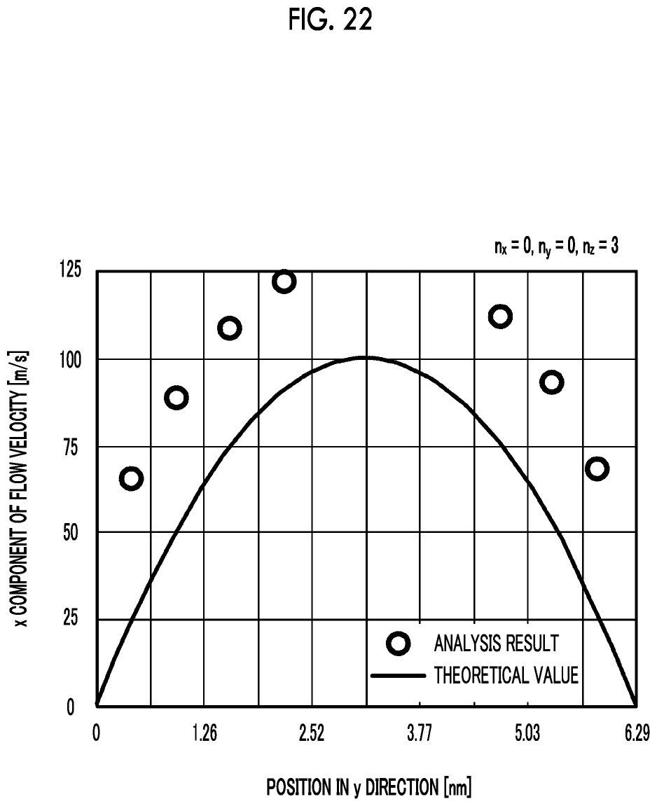

FIGS. 19 to 22 are graphs showing results of the analysis performed by using the renormalization transformation rule shown in equation (33). FIG. 19 shows an analysis result in a case where the renormalization is performed isotropically three times each. FIG. 20, FIG. 21, and FIG. 22 show analysis results in a case where the renormalization is performed three times in the x direction, the y direction, and the z direction, respectively, and the renormalization is not performed in the other directions. The average errors of the analysis results shown in FIGS. 19, 20, 21, and 22 with respect to the theoretical values are respectively approximately 4.1%, approximately 33.6%, approximately 86.9%, and approximately 71.1%. Although the renormalization conditions are the same in FIGS. 15 and 19, there is a difference in the analysis results due to the influence of initial disposition of the particles 31, a difference in random numbers in a case where the random force Rᵢ in equation (3) is generated, or the like. The difference therein is considered to be smaller in a case where the ensemble is taken for a long time.

It can be seen that in a case where the renormalization is performed isotropically, the analysis result matches well the theoretical value even in a case where the transformation rule of equation (33) is used. However, in a case where the anisotropic renormalization is performed, the analysis result deviates significantly from the theoretical value in a case where the transformation rule of equation (33) is applied. It can be seen that in a case where the anisotropic renormalization is performed, the transformation rule of equation (33) cannot be applied.

From the analysis result shown in FIG. 6, it is confirmed that in a case where the renormalization is not performed, the flow of the fluid in contact with the wall surface 40 can be accurately analyzed by the simulation method according to the embodiment described with reference to FIGS. 1A to 4. From the analysis results shown in FIGS. 7 to 18, it is confirmed that in a case where the isotropic or anisotropic renormalization is performed, the flow of the fluid in contact with the wall surface 40 can be accurately analyzed by using the transformation rule of equation (34). From the analysis result shown in FIG. 19, it is confirmed that in a case where the isotropic renormalization is performed, the flow of the fluid in contact with the wall surface 40 can be accurately analyzed by using the transformation rule of equation (33).

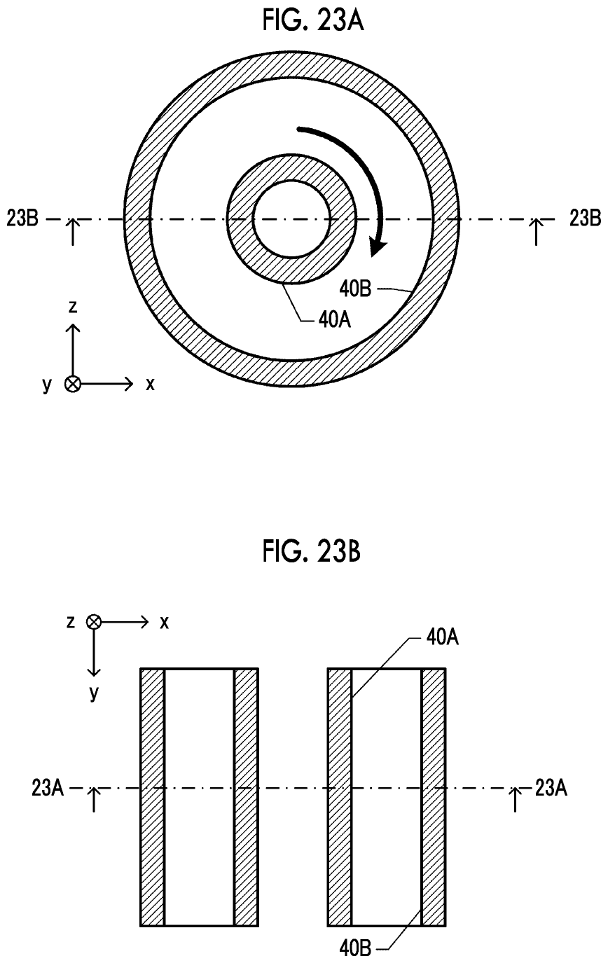

Next, a simulation method and a simulation device according to still another embodiment will be described with reference to FIGS. 23A and 23B.

In the embodiment shown in FIG. 5, the renormalization method has been described by taking the fluid flowing between two parallel wall surfaces 40 in one direction as an example. The transformation rule shown in equation (34) is also applicable to a rotating flow.

FIG. 23A and FIG. 23B are cross-sectional views of an analysis model to be analyzed in the simulation method according to the present embodiment. FIG. 23A is a cross-sectional view taken along a line 23A-23A of a single point chain line of FIG. 23B, and FIG. 23B is a cross-sectional view taken along a line 23B-23B of a single point chain line of FIG. 23A.

Two cylindrical wall surfaces 40A and 40B having different diameters are concentrically disposed. A flow path around which the fluid revolves is formed between the wall surfaces 40A and 40B. An xyz orthogonal coordinate system is defined in which a direction parallel to a center axis of the cylindrical wall surfaces 40A and 40B is set as the y direction. Since the x direction and the z direction are equivalent to each other, the number of times of renormalization in the x direction and the number of times of renormalization in the z direction are set to be the same in a case where the renormalization is performed. In this case, the renormalization factor λₓ in the x direction and the renormalization factor λ_{z} in the z direction are equal to each other. In a case where the renormalization factor in the x direction and the z direction is marked as λ_{xz}, equation (34) is modified as follows.

$${γ}_{R} = \frac{{{λ}_{y}}^{\frac{4}{3}} {{λ}_{z}}^{\frac{4}{3}}}{{{λ}_{x}}^{\frac{2}{3}}} γ = {{λ}_{xz}}^{\frac{2}{3}} {{λ}_{y}}^{\frac{4}{3}} γ \qquad ( 36 )$$

With the use of the transformation rule of equation (36), it is possible to analyze the rotating fluid. The above transformation rule can be applied to, for example, an analysis of a flow of a fluid in a stirring tank, with the outer wall surface 40B as a casing and the inner wall surface 40A as a stirring blade.

It is needless to say that each of the above embodiments is an example, and partial substitutions or combinations of the configurations shown in different embodiments are possible. Similar action effects due to the configuration similar to the plurality of embodiments will not be sequentially referred to for each embodiment. Further, the present invention is not limited to the above embodiment. For example, it will be obvious to those skilled in the art that various changes, improvements, combinations, and the like are possible.

It should be understood that the invention is not limited to the above-described embodiment, but may be modified into various forms on the basis of the spirit of the invention. Additionally, the modifications are included in the scope of the invention.

What is claimed is:

1. A simulation method
in which a fluid flowing in contact with a wall surface is represented by a plurality of particles,
particle-wall surface interaction between the plurality of particles and the wall surface and interparticle interaction between the plurality of particles are determined, and
an equation of motion governing motion of the plurality of particles is solved for each of the plurality of particles to develop positions and velocities of the plurality of particles over time, the simulation method comprising:
causing, in a case where the equation of motion is solved, attenuation force received from the wall surface and random force according to a temperature of the wall surface, in addition to force due to the interparticle interaction and the particle-wall surface interaction, to act on a particle, among the plurality of particles, whose distance to the wall surface is equal to or less than a first distance set in a simulation condition to develop a position and a velocity of a particle over time.

2. The simulation method according to claim 1,
wherein the fluid flows in one direction,
the plurality of particles are renormalized, in a case where an xyz orthogonal coordinate system is defined in which a flow direction of the fluid is set as an x direction, in at least one of the x direction, a y direction, or a z direction,
in a case where the number of times of renormalization in the x direction, the y direction, and the z direction is marked as nₓ, n_{y}, and n_{z}, respectively,
renormalization factors λₓ, λ_{y}, and λ_{z} that represent a degree of renormalization are marked as
λₓ=2ⁿ^{ₓ}
λ_{y}=2ⁿ^{_{y}}
λ_{z}=2ⁿ^{_{z}}
and
an attenuation coefficient before the renormalization of the attenuation force is marked as γ and an attenuation coefficient after the renormalization is marked as γ_{R}, the attenuation coefficient γ_{R} after the renormalization is calculated by applying a transformation rule
$${γ}_{R} = \frac{{{λ}_{y}}^{\frac{4}{3}} {{λ}_{z}}^{\frac{4}{3}}}{{{λ}_{x}}^{\frac{2}{3}}} γ$$
and
the attenuation coefficient γ_{R} after the renormalization is used in a case where the equation of motion is solved.

3. A simulation device that analyzes a flow of a fluid flowing along a wall surface, the simulation device comprising:
an input unit that receives a simulation condition;
a processing unit that analyzes the flow of the fluid based on the simulation condition input to the input unit; and
an output unit that outputs an analysis result obtained by the processing unit,
wherein the processing unit
represents the fluid with a plurality of particles based on the simulation condition input to the input unit,
solves an equation of motion governing motion of the plurality of particles for each of the plurality of particles to develop positions and velocities of the plurality of particles over time, and
causes, in a case where the equation of motion is solved, force due to interparticle interaction and particle-wall surface interaction set in the simulation condition, attenuation force received from the wall surface, and random force according to a temperature of the wall surface, to act on a particle, among the plurality of particles, whose distance to the wall surface is equal to or less than a first distance set in the simulation condition to develop a position and a velocity of a particle over time.

4. The simulation device according to claim 3,
wherein the simulation condition includes a renormalization condition in which the plurality of particles are renormalized,
the fluid flows in one direction,
the renormalization condition includes, in a case where an xyz orthogonal coordinate system is defined in which a flow direction of the fluid is set as an x direction, information that designates the number of times of renormalization nₓ, n_{y}, and n_{z} in the x direction, a y direction, and a z direction,
in a case where renormalization factors λₓ, λ_{y}, and λ_{z} that represent a degree of renormalization are marked as
λₓ=2ⁿ^{ₓ}
λ_{y}=2ⁿ^{_{Y}}
λ_{z}=2ⁿ^{_{z}}
and
an attenuation coefficient before the renormalization of the attenuation force is marked as γ and an attenuation coefficient after the renormalization is marked as γ_{R}, the processing unit calculates the attenuation coefficient γ_{R} after the renormalization by applying a transformation rule
$${γ}_{R} = \frac{{{λ}_{y}}^{\frac{4}{3}} {{λ}_{z}}^{\frac{4}{3}}}{{{λ}_{x}}^{\frac{2}{3}}} γ$$
and
uses the attenuation coefficient γ_{R} after the renormalization in a case where the equation of motion is solved.

5. A non-transitory computer readable medium storing a program that causes a computer to execute a procedure of analyzing a flow of a fluid flowing along a wall surface, the procedure comprising:
a procedure of acquiring a simulation condition; and
a procedure of analyzing the flow of the fluid based on the acquired simulation condition,
wherein the procedure of analyzing the flow of the fluid includes
a procedure of representing the fluid with a plurality of particles based on the acquired simulation condition, and
a procedure of solving an equation of motion governing motion of the plurality of particles for each of the plurality of particles to develop positions and velocities of the plurality of particles over time, and
in a case where the equation of motion is solved, force due to interparticle interaction and particle-wall surface interaction set in the simulation condition, attenuation force received from the wall surface, and random force according to a temperature of the wall surface are caused to act on a particle, among the plurality of particles, whose distance to the wall surface is equal to or less than a first distance set in the simulation condition to develop a position and a velocity of a particle over time.

6. The non-transitory computer readable medium storing a program according to claim 5,
wherein the simulation condition includes a renormalization condition in which the plurality of particles are renormalized,
the fluid flows in one direction,
the renormalization condition includes, in a case where an xyz orthogonal coordinate system is defined in which a flow direction of the fluid is set as an x direction, information that designates the number of times of renormalization nₓ, n_{y}, and n_{z} in the x direction, a y direction, and a z direction,
in a case where renormalization factors λₓ, λ_{y}, and λ_{z} that represent a degree of renormalization are marked as
λₓ=2ⁿ^{ₓ}
λ_{y}=2ⁿ^{_{y}}
λ_{z}=2ⁿ^{_{z}}
and
an attenuation coefficient before the renormalization of the attenuation force is marked as γ and an attenuation coefficient after the renormalization is marked as γ_{R}, the procedure of analyzing the flow of the fluid includes a procedure of calculating the attenuation coefficient γ_{R} after the renormalization by applying a transformation rule
$${γ}_{R} = \frac{{{λ}_{y}}^{\frac{4}{3}} {{λ}_{z}}^{\frac{4}{3}}}{{{λ}_{x}}^{\frac{2}{3}}} γ$$
and
uses the attenuation coefficient γ_{R} after the renormalization in a case where the equation of motion is solved.
